(19) United States
(12) Patent Application Publication
(10) Pub. No.: US 2007/0221839 A1
(43) Pub. Date: Sep. 27, 2007

(54) Analytical system and method

(76) Inventors: Paul C. Goodley, Cupertino, CA (US); Bernd Glatz, Leonberg, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/388,686

(22) Filed: Mar. 24, 2006

(51) Int. Cl. H01J 49/04

(52) U.S. Cl. 250/288

(57) ABSTRACT

The invention provides an analytical system having a separating system and a liquid chromatography chip. The liquid chromatography chip has an emitter that includes a material that prevents charge buildup on the emitter surface. Methods of using the analytical system, chip and emitter are also disclosed.

### BACKGROUND

Most complex biological and chemical targets require the application of complementary multidimensional analysis tools and methods to compensate for target and matrix interferences. Correct analysis and separation is important to obtain reliable quantitative and qualitative information about a target. In this regard, analytical systems have been employed to separate various types of molecules. Such separations have been accomplished with good speed and accuracy. More recently these systems have been closely coupled with mass spectrometry systems. The combination of liquid chromatography and mass spectrometry systems provides for an ideal separation and identification of molecules at high speed.

In most situations, researchers and scientists use these techniques for separation and identification. Therefore, it is desirable to use less and less sample since the characterization and identification often can not recapture or save the materials separated and identified. As a result, most of the analytical systems and emitters have moved towards testing on smaller and smaller samples. With these changes have also come changes in the design of the devices used for separation and characterization. For instance, new chips or small scale emitters have been developed for the processing and characterization of small sample volumes. Generally, speaking small chips with electrospray emitters have been developed for use in the characterization of the molecules that have been separated using liquid chromatography. However, when very few conductive gases or non-conductive environments are present, the emitters and their surfaces will often create a build up of charged particles. This happens most often under atmospheric or subatmospheric pressures. Generally, after there is a buildup of charged particles, the electrospray will become unstable and eventually stop spraying without additional intervention. Even with additional intervention of increasing the potential voltage to the electrodes, the chemical analysis may change and cause degradation and/or incorrect ion products to be analyzed.

Thus, there is a need to improve the apparatus and method for reducing surface charge generation in analytical systems, chips and emitters. These and other problems present in the art have been obviated by the present invention.

### SUMMARY OF THE INVENTION

The present invention relates to an apparatus and method for reducing charge buildup on an analytical system, chip and/or emitter.

The invention provides an analytical system, comprising a separation system for separating a sample, and a liquid chromatography chip adjacent to the separation system and in fluid communication with the separation system, the liquid chromatography chip comprising a material that prevents charge buildup on the liquid chromatography chip.

The invention also provides a liquid chromatography chip for electrospray. The chip comprises an inlet port, a spray chamber, and a spray emitter. The inlet port is in fluid communication with the spray chamber. The spray chamber is in fluid communication with the electrospray emitter. The electrospray emitter comprises a material or coating that prevents charge buildup on the electrospray emitter.

The invention also provides a method. The method comprises providing or coating an electrospray emitter with a material to prevent charge buildup on the electrospray emitter and passing an analyte through the electrospray emitter.

### BRIEF DESCRIPTION OF THE FIGURES

The invention is described in detail below with reference to the following figures:

FIG. 1 shows a general block diagram of an analytical system.

FIG. 2 shows a perspective view of the LC chip and holder outside the interface slot.

FIG. 3 shows a perspective view of the LC chip and holder inserted into the interface slot.

FIG. 4 shows a perspective view of the LC chip and holder of the present invention.

FIG. 5 shows a cross sectional view of the LC chip coating of the present invention.

FIG. 6A shows a front view of the LC chip.

FIG. 6B shows a rear view of the LC chip.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “an emitter” includes more than one “emitter”. Reference to a “hydrophobic material” includes more than one “hydrophobic material” or a mixture of “hydrophobic materials”. In describing and claiming the present invention, the following terminology will be used in accordance with the definitions set out below.

The term “adjacent” means, near, next to or adjoining. Something adjacent may also be in contact with another component, surround the other component, be spaced from the other component or contain a portion of the other component. For instance, a capillary that is adjacent to an emitter may be spaced next to the emitter, may contact the emitter, may surround or be surrounded by the emitter, may contain the emitter or be contained by the emitter, may adjoin the emitter or may be near the emitter.

The term “sample” refers to the analyte of interest combined with a solvent or other carrier.

The term “analytical system” refers to any system capable of separating and characterizing molecules. In certain instances this type of system may include and not be limited to a liquid chromatography system coupled to a mass spectrometry system.

The term “charge buildup” refers to the accumulation of positive or negative charges on the surface of a LC chip. This may be limited to a single charge or multiple charges.

The term “chip interface” refers to any interface capable of receiving a LC chip. The term includes the housing and associated parts for receiving a LC chip. In certain instances or embodiments the design may include an ion source. In other embodiment the ion source may be separate.

The term “coating” refers to the addition or deposition of one or more layers on a substrate or material. For instance, the LC chip may comprise a coating of hydrophobic materials.

The term “detector” refers to any device, apparatus, machine, component, or system that can detect an ion. Detectors may or may not include hardware and software. In a mass spectrometer the common detector includes and/or is coupled to a mass analyzer.

The term “ion source” or “source” refers to any source that produces analyte ions. Ion sources may include various ion sources known in the art. Some sources include but are not limited electron impact (EI), chemical ionization (CI), photoionization (APPI), and matrix assisted laser desorption ionization (MALDI). The sources may be under vacuum or at atmospheric pressure, or below atmospheric pressure.

The term “mass spectrometry system” refers to the combination of a mass analyzer, transport system and detector. These systems or components may be connected or associated with one another in various ways.

The term “on” should be interpreted to be broad based. For instance, charge buildup on a LC chip may take place anywhere on the LC chip and/or the surface of the LC chip. In certain instances, this may be limited to defined surfaces of the LC chip, or the entire surface of the LC chip.

The term “separation system” refers to any system capable of separating or characterizing molecules. For instance, a separation system may comprise a liquid chromatography system and associated parts. Chromatography systems generally comprise a column for use in the separation. Columns may be analytical or preparative, depending upon the intended use and quantity for separation. Other systems known in the art may also be employed.

The invention is described with reference to the figures. The figures are not to scale, and in particular, certain dimensions may be exaggerated for clarity of presentation.

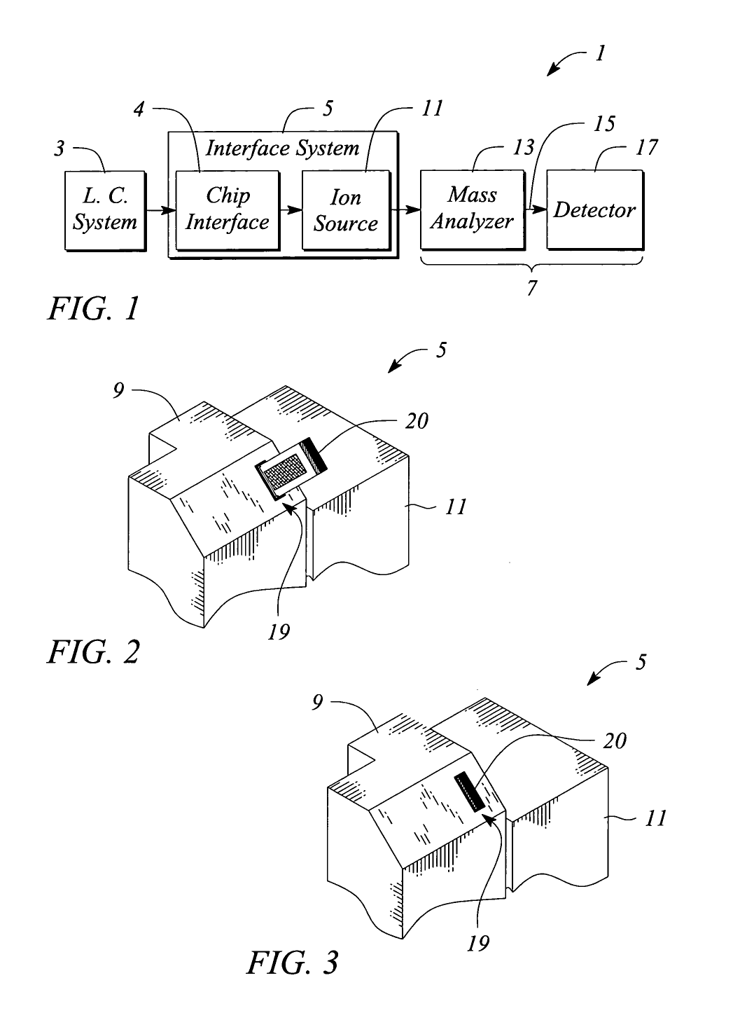

FIG. 1 shows a general block diagram of an analytical system 1. The analytical system 1 comprises a separation system 3, an interface 5 and a mass spectrometry system 7. The block diagram is not to scale and is drawn in a general format because the present invention may be used with a variety of different types of designs and systems. Each of the systems will be described in more detail.

The separation system 3 may comprise any number of systems known in the art for separating molecules. More commonly this may be an analytical system such as a liquid chromatography system (LC). However, other systems and methods known in the art may be employed depending upon the type of molecule being employed. For instance, the separation system 3 may also comprise an electrophoresis system and/or apparatus, an isoelectric focusing system and/or apparatus, a biorad or similar type preparative electrophoresis system and/or apparatus, a two dimensional gel, and other systems and/or apparatus that are known in the art for separating molecules. FIG. 1 shows an embodiment of the invention where an analytical system is employed. The analytical system may comprise a high performance liquid chromatography (HPLC) and associated equipment. These parts and designs are well known in the art and are, therefore, not described here in any further detail.

The interface system 5 is interposed between the separation system 3 and the mass spectrometry system 7. FIG. 1 shows the interface system 5 in an independent configuration relative to mass spectrometry system 7. However, in certain embodiments the interface system 5 may comprise a part of either the separation system 3 or the mass spectrometry system 7. In other embodiments each of the separate systems including the separation system 3, the interface 5 and the mass spectrometry system 7 may be incorporated into a single system or housing (not shown in figures). Therefore, the present design and diagrams should not be interpreted to limit the broad scope of the invention.

FIGS. 1-3 show the interface system 5 further comprising a chip interface 9 and an ion source 11. The chip interface 9 is shown adjacent to the ion source 11 in the figure. However, in certain embodiments the chip interface 9 and the ion source 11 may comprise a single unit. In other words the chip interface 9 and the ion source 11 may be designed or positioned in a single housing. Other embodiments are also possible. However, it is important to the invention that the chip interface 9 may be coupled to or part of the ion source 11.

The mass spectrometry system 7 is also shown in FIG. 1-3. The mass spectrometry system 1 comprises a mass analyzer 13, a transport system 15 and a detector 17. The transport system 15 is used for transporting ions and is typically interposed between the mass analyzer 13 and the detector 17. However, this is not a required configuration. The mass analyzer 13 is used for separating and determining the m/z ratio of the ions produced by the ion source 11.

Typical mass analyzers may comprise a time of flight (TOF), ion trap, quadrupole, hexapole, octapole, triple quadrupole, quick time of flight (Q-TOF), fast atom bombardment, and others known in the art.

The transport system 15 may comprise any number of ion transporting devices known in the art. Typically some time of skimmer or ion optics guide may also be employed in the transport system 15. Transport systems 15 are well known in the art and are, therefore, not discussed in detail here.

The detector 17 is positioned downstream from the transport system 15 and may comprise any number of detectors known and used in the art. Some typical detectors may include photomultiplier tubes or other similar type technology. The detectors may be coupled to a computer and interface for output of the results to a third party user interface (not shown in the FIGS.).

FIG. 2 shows a perspective view of the interface system 5 which may typically be associated with the mass spectrometry system 7. The drawing illustrates an embodiment in which the ion source 11 is closely coupled with the chip interface 9. The chip interface 9 comprises a chip slot 19 designed for receiving the liquid chromatograph (LC) chip 20. The LC chip 20 may then be inserted into the chip slot 19 (See FIG. 3).

FIG. 3 shows when the LC chip 20 is inserted into the chip slot 19, the LC chip 20 serves as the emitter for the ion source 11. A capillary 23 is disposed in the ion source 11 adjacent to the LC chip 20 and is designed for receiving ions produced and emitted from the LC chip 20 (not shown in FIGS.). Details of the LC chip 20 will now be provided.

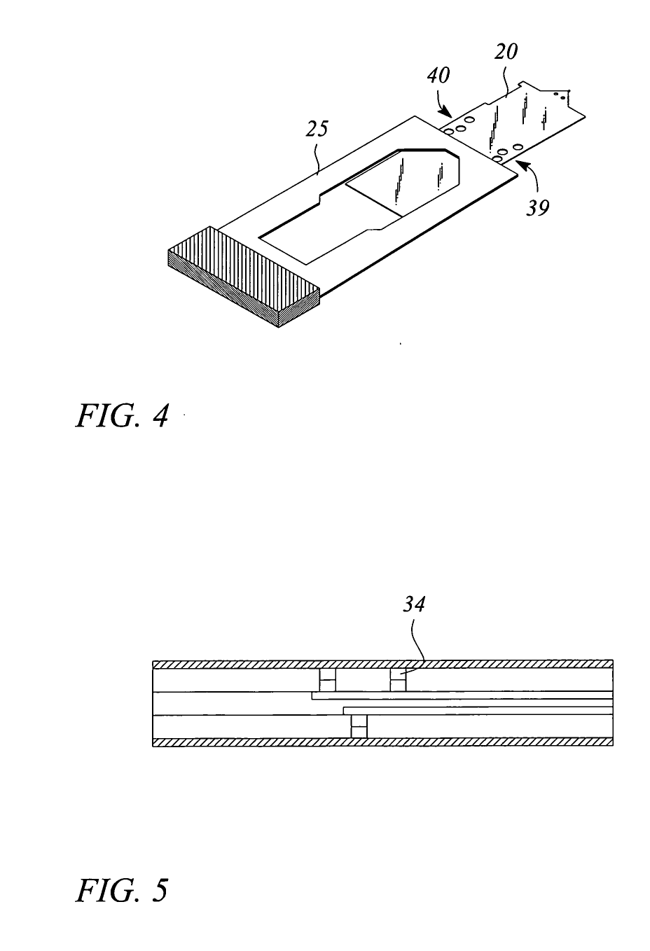

FIG. 4 shows the LC chip 20 and chip holder 25. The LC chip 20 has been partially inserted and positioned in a chip holder 25. Chip holder 25 is designed to hold and position the LC chip 20 in the chip slot 19. In addition, the chip holder 25 allows for the LC chip 20 to be extended in and out of the chip holder 25. This is important since the LC chip 20 needs to be positioned in an ionization region adjacent to a capillary or similar type device. This provides for proper production and collection of ions. The LC chip 20 can be taken out of the chip slot 19 and chip interface 9 after use and replaced if desired.

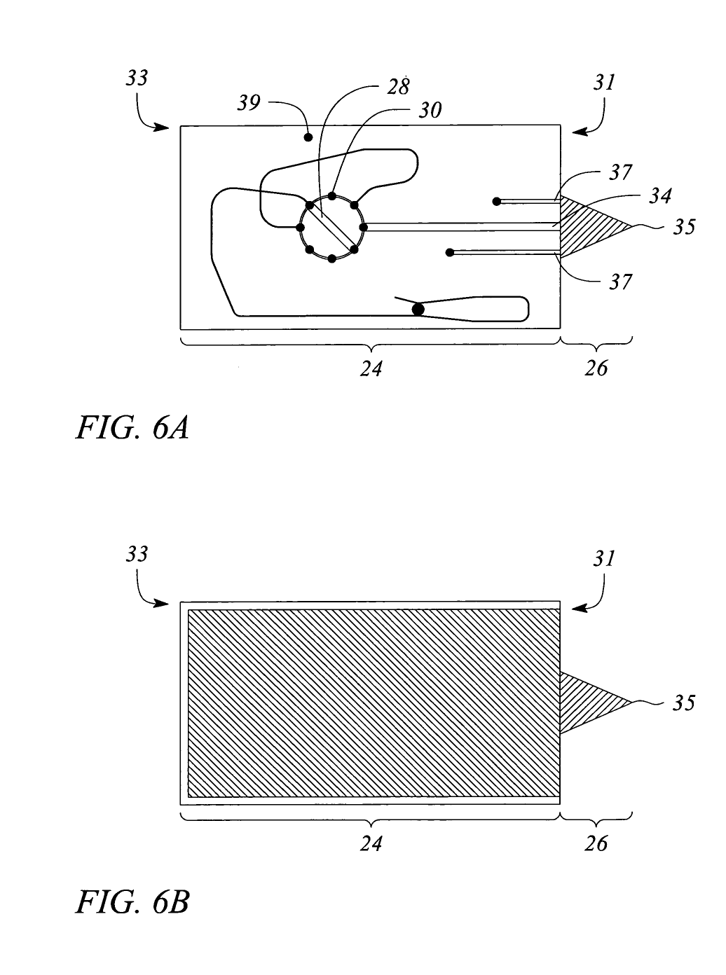

FIGS. 5 and 6 show the LC chip 20 and associated parts. The LC chip 20 has been removed from the chip holder 25. The LC chip 20 comprises a polymeric material such as polyimide or other similar type materials know in the art for constructing such structures and apparatus. The material is flexible and durable and capable of designing one or more channels within the material. In addition, this material is ideal for constructing microfluidic channels and designs due to its durability and strength even with small cross sectional pieces. The LC chip 20 comprises a body portion 24 and a tip portion 26. The LC chip also has a first end 31 and a second end 33 opposite the first end 31. Generally at the second end 33 the LC chip 20 comprises one or more liquid inlet ports 30. These inlet ports 30 are designed for receiving one or more fluids that will be directed toward one or more channels 34. These channels may be in fluid communication with one or more switching values or trapping columns. Switching valves 28 may be employed for switching between wash or sample inputs. Trapping columns may be employed for removing contaminants or other similar type materials from the fluid stream. The spray chamber 34 runs the length of the LC chip 20 and exits at the emitter tip 35. The LC chip 20 may also comprise one or more registration holes 39 and 40 that are employed for securing and aligning the LC chip 20 in the chip holder 25 (See FIG. 4). The LC chip 20 also comprises one or more metal traces 37 that run along the first end 31 of the LC chip 20 and connect to the emitter tip 35. The metal traces 37 connect to one or more electrical contacts.

Important to the invention is the emitter tip 35. The emitter tip 35 may comprise or be coated with a hydrophobic material. The emitter tip 35 typically gains a charge from the ions that are being sprayed or emitted from the emitter tip 35. One or more emitter tips 35 may be employed. The figure shows an embodiment in which only one emitter tip 35 is employed.

Having discussed the apparatus of the invention in detail, a description of the method of operation of the invention is now in order.

After the LC chip 20 has been inserted into the chip slot 19 on the chip interface 9, the instrument is ready to operate. The LC chip 20 is then typically secured in place using one or more clamping plates (not shown in picture) and the registration holes 39 and 40. Next, the chip interface 9 typically activates to lower or slide the emitter tip 35 into place in the ionization region 27 (not shown). When the LC chip 20 is complete in operation or has completed its task, the emitter tip 35 may be retracted from the ionization region 27 back into the chip holder 25. A detailed description of the LC chip 20 is now in order.

Sample is typically supplied to the LC chip 20 through one or more of the input ports 30. A switching valve may be employed to switch between sample source as well as a wash or buffer line. The sample then is directed into a trapping column and then channel. The sample then runs through the channel until it reaches the emitter tip 35 where it is discharged. During operation of the LC chip 20 the charge from the ions being discharged will typically collect across the surface of the LC chip 20. This is because the LC chip 20 is typically maintained at ground, while the capillary is maintained at potential. The voltage between the capillary and ground is around 120 V. In particular, the areas of greatest charge collection on the surface of the LC chip 20 are near the emitter tip 35. A hydrophobic material may comprise or be applied as a coating to the emitter tip 35 and/or the entire LC chip 20. This prevents charge buildup on the surface of the LC chip 20. Preventing charge buildup is important for the correct operation of the instrument and LC chip. Added charges interfere with the spraying of the ions and often times the emitter tip 35 will become blocked or inhibited by the ions during the charge buildup. This problem, therefore, negatively effects the whole instrument operation as well as the output and sensitivity of the instruments.

The emitter tip 35 may comprise or be coated with a hydrophobic material. As discussed, these hydrophobic materials allow for improved instrument operation. They held in preventing charge buildup across the face of the surface of the LC chip 20. After the ions have been sprayed from the emitter tip 35 they are collected by the capillary 23 and then passed onto the detector 17 that is further downstream in the system.

We claim:

1. An analytical system, comprising:
(a) a separation system for separating a sample, and
(b) a liquid chromatography chip adjacent to the separation system and in fluid communication with the separation system, and comprising a material that prevents charge buildup on the liquid chromatography chip.

2. An analytical system as recited in claim 1, wherein the separation system comprises an analytical column.

3. An analytical system as recited in claim 1, wherein the liquid chromatography chip comprises a coating that prevents charge buildup on the liquid chromatography chip.

4. An analytical system as recited in claim 1, wherein the liquid chromatography chip comprises a metal that prevents charge buildup on the liquid chromatography chip.

5. An analytical system as recited in claim 1, wherein the liquid chromatography chip comprises a metal coating that prevents charge buildup on the liquid chromatography chip.

6. An analytical system as recited in claim 1, wherein the liquid chromatography chip may be operated at atmospheric pressure.

7. An analytical system as recited in claim 1, wherein the liquid chromatography chip may be operated at subatmospheric pressures.

8. A liquid chromatography chip for electrospray, comprising an inlet port, a spray chamber, and an electrospray emitter having an electrospray emitter surface, wherein the inlet port is in fluid communication with the spray chamber, the spray chamber is in fluid communication with the electrospray emitter and wherein the electrospray emitter comprises a material that prevents charge buildup on the electrospray emitter surface.

9. A liquid chromatography chip for electrospray as recited in claim 8, wherein the electrospray emitter surface comprises a hydrophobic material that prevents charge buildup on the electrospray emitter surface.

10. A liquid chromatography chip for electrospray as recited in claim 8, wherein the electrospray emitter comprises a hydrophobic coating that prevents charge buildup on the electrospray emitter surface.

11. A liquid chromatography chip for electrospray as recited in claim 8, wherein the electrospray emitter comprises a metal material that prevents charge buildup on the electrospray emitter surface.

12. A liquid chromatography chip for electrospray as recited in claim 8, wherein the electrospray emitter comprises a metal coating that prevents charge buildup on the electrospray emitter surface.

13. A liquid chromatography chip for electrospray as recited in claim 8, wherein the liquid chromatograpy chip may be operated at atmospheric pressure.

14. A liquid chromatography chip for electrospray as recited in claim 8, wherein the liquid chromatography chip may be operated at subatmospheric pressures.

15. An electrospray emitter for preventing charge buildup, comprising:
(a) a body portion; and
(b) a tip portion in association with the body portion, the tip portion comprising a material that prevents charge buildup on the tip portion of the electrospray emitter.

16. An electrospray emitter as recited in claim 15, wherein the electrospray emitter comprises a hydrophobic material that prevents charge buildup on the tip portion of the electrospray emitter.

17. An electrospray emitter as recited in claim 15, wherein the electrospray emitter comprises a hydrophobic coating that prevents charge buildup on the tip portion of the electrospray emitter.

18. An electrospray emitter as recited in claim 15, wherein the electrospray emitter comprises a metal material that prevents charge buildup on the tip portion of the electrospray emitter.

19. An electrospray emitter as recited in claim 15, wherein the electrospray emitter comprises a metal coating that prevents charge buildup on the tip portion of the electrospray emitter.

20. An electrospray emitter as recited in claim 15, wherein the electrospray emitter may be operated at atmospheric pressure.

21. An electrospray emitter as recited in claim 15, wherein the electrospray emitter may be operated at subatmospheric pressures.

22. A method of preventing charge buildup on an electrospray emitter of a liquid chromatography chip, comprising:
(a) coating the electrospray emitter with a hydrophobic material; and
(b) passing molecules through electrospray emitter.

23. A method of preventing charge buildup on an electrospray emitter of a liquid chromatography chip, comprising:
(a) coating the electrospray emitter with a metal material; and
(b) passing molecules through the electrospray emitter.

24. A method to electrospray from an electrospray emitter of a liquid chromatography chip, comprising:
(a) coating the electrospray emitter with a material that prevents charge buildup on the electrospray emitter; and
(b) passing an analyte through the electrospray emitter.

25. A method to electrospray from an electrospray emitter of a liquid chromatography chip, comprising:
(a) coating the electrospray emitter with a metal material that prevents charge buildup on the electrospray emitter; and
(b) passing an analyte through the electrospray emitter.

26. A method to electrospray from an electrospray emitter of a liquid chromatography chip, comprising:
(a) providing an electrospray emitter with a hydrophobic material that prevents charge buildup on the electrospray emitter; and
(b) passing an analyte through the electrospray emitter.
